(19) United States
(12) Patent Application Publication
(10) Pub. No.: US 2007/0151164 A1
(43) Pub. Date: Jul. 5, 2007

(54) Continuous hinge for swing door

(76) Inventor: Danny Ray Marshall, Winchester, CA (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/325,657

(22) Filed: Jan. 4, 2006

(51) Int. Cl. E05D 7/00

(52) U.S. Cl. 49/397

(57) ABSTRACT

A hinge is provided for connecting a swing door to an adjacent support structure. The hinge includes a first attachment structure for being mounted to either the door or the adjacent support structure and has a partially cylindrical channel defining a longitudinal pivot axis. A second attachment structure is mounted to the other of the door and adjacent support structure, and has a longitudinally extending mounting arm projecting into the partially cylindrical channel of the first attachment structure. A bushing (1) is mounted on the arm of the second attachment structure, (2) is disposed in the partially cylindrical channel of the first attachment structure, and (3) has a partially cylindrical exterior surface which (a) is defined around the pivot axis for engaging the partially cylindrical channel of the first attachment structure, and (b) has a surface hardness that is less than the surface hardness of the partially cylindrical channel.

### CROSS REFERENCE TO RELATED APPLICATION(S)

None.

### STATEMENT REGARDING FEDERALLY SPONSORED RESEARCH OR DEVELOPMENT

None.

### REFERENCE TO A MICROFICHE APPENDIX

None.

### TECHNICAL FIELD

This invention relates to a system for mounting a door for pivoting or swinging about an axis. The invention is more particularly related to a hinge, and the hinge is especially suitable for use with a glass door, particularly a glass door for a shower room or other enclosure.

### BACKGROUND OF THE INVENTION AND TECHNICAL PROBLEMS POSED BY THE PRIOR ART

A variety of problems or potential problems are presented to the designer of a hinge or multiple hinges that are used to mount a door for swinging between a closed position and an open position.

For some types of doors and some types of installations, it would be desirable to provide an improved hinge design to accommodate particular conditions in a cost-effective manner, but also in a manner that is aesthetically pleasing, that provides a strong and safe support, that operates well in a variety of conditions, that has a long life, and that is not unduly complicated and time-consuming to install.

Nowadays, there is a need for an improved hinge system that is suitable for various types of doors, and that is especially suitable for use in modem bathrooms, such as for mounting a shower door to a shower stall or shower room. Designers of modem bathrooms typically attempt to provide an enhanced aesthetic appearance with respect to architectural details, including shower doors and mounting systems for such shower doors. Contemporary styles frequently include a glass shower door. Some desirable shower glass door designs employ a relatively thick, heavy panel of glass.

The use of a heavy panel of glass requires that the hinge system be designed to accommodate the increased load for safe installation and operation. The use of glass, regardless of its thickness or weight, also presents the hinge system designer with various aesthetic issues arising from the transparent nature of the glass. Certain parts of the hinge system which might normally not be visible on an opaque door may be visible to some extent on a transparent, glass door.

Further, a door used in a shower enclosure, whether or not the door is made from transparent glass, is subjected to a wet environment, and the hinge system must be able to withstand such a wet environment. Additionally, a door and hinge system in such a wet environment might be expected to prevent, or at least minimize, the escape of water from the interior side of the door through the hinge system to the exterior side of the door.

With heavy doors, the greater weight must be safely accommodated by the hinge system over the design life of the door so that the hinge system does not catastrophically fail in a way that might cause the door to fall. Moreover, in some hinged door installations, it may be desirable to provide a range of opening that is more than 90 degrees.

It would be desirable to provide a hinge system with an improved design relative to one or more of the above-discussed design considerations.

It would also be beneficial if such an improved hinge system design could accommodate use with a glass door that is either fully framed or frameless. In a framed shower door, the glass door is completely framed about its perimeter with a metal frame which may comprise, for example, aluminum channel members. A frameless glass door typically has no frame members on the top edge, bottom edge, or along the vertical side edge that opens and closes against the door opening.

It would also be desirable to provide an improved hinge system which would at least minimize, if not eliminate, the possibility of cracking a glass door in the hinge area.

It would also be advantageous if such an improved hinge system could be readily fabricated in a variety of sizes and shapes for different applications.

It would also be beneficial if such an improved hinge system could accommodate minor manufacturing tolerances.

Further, it would be desirable if such an improved hinge system could function over a long period of time, throughout many cycles of door openings and closings, without causing excessive wear or discoloration of the hinge system components.

The present invention provides an improved hinge which can accommodate designs having one or more of the above-discussed benefits and features.

### BRIEF SUMMARY OF THE INVENTION

According to one aspect of the present invention, a hinge is provided for connecting a swing door to an adjacent support structure in a hinged relationship. The hinge includes a first attachment structure for being mounted to either the adjacent support structure or the door. The first attachment structure has a partially cylindrical channel defining a longitudinal pivot axis. In a preferred embodiment, the first attachment structure may be, or may function as, a jamb that can be mounted to an adjacent wall defining one edge of the doorway opening.

A second attachment structure is provided for being mounted to the other of the door and adjacent support structure. The second attachment structure has a longitudinally extending mounting arm projecting into the partially cylindrical channel of the first attachment structure. In a preferred embodiment, the second attachment structure may be, or may function as, a frame member or a stile that is mounted on the door.

A bushing is mounted on the projecting arm of the second attachment structure and is disposed in the partially cylindrical channel of the first attachment structure. The bushing has a partially cylindrical exterior surface which (1) is defined around the hinge pivot axis for engaging the partially cylindrical channel of the first attachment structure, and (2) has a surface hardness that is less than the surface hardness of the partially cylindrical channel. This arrangement permits the second attachment structure to rotate at least part way around the pivot axis.

In a preferred embodiment, the first and second attachment structures are metallic (e.g., aluminum), and the bushing is a thermoplastic polymer (e.g., nylon or polyvinylchloride).

In a preferred form of the invention, the second attachment structure includes a metal stile and a metal hinge insert mounted in the stile. The insert extends laterally from the stile and defines the projecting arm to which the bushing is mounted.

The hinge can optionally include one or more spacers in an arrangement wherein the hinge has a plurality of bushings and a plurality of inserts. Preferably, each bushing and insert have the same length, and that length is shorter than the length of the first attachment structure and second attachment structure. The bushings and inserts are arranged in cooperative subassemblies wherein each subassembly consists of one bushing mounted on one insert. The subassemblies are longitudinally spaced apart along the pivot axis. In each space between the spaced-apart subassemblies, there is one longitudinal spacer.

In a preferred embodiment, the second attachment structure includes a metal stile, and the inserts and spacers are each mounted to the stile. Each spacer preferably includes (1) a retention portion mounted in the stile, (2) a partially cylindrical wall that is disposed radially outwardly of the partially cylindrical channel of the first attachment structure, and (3) a pintle that (a) is disposed in the partially cylindrical channel of the first attachment structure, and (b) has a partially cylindrical exterior surface defined around the pivot axis for engaging the partially cylindrical channel of the first attachment structure to accommodate rotation of the spacers with the inserts and stile at least partway around the pivot access.

Numerous other advantages and features of the present invention will become readily apparent from the following detailed description of the invention, from the claims, and from the accompanying drawings.

### BRIEF DESCRIPTION OF THE DRAWINGS

In the accompanying drawings that form part of the specification, and in which like numerals are employed to designate like parts throughout the same,

FIG. 1 is a simplified, fragmentary, perspective view of a first embodiment of the hinge of the present invention shown mounting a door to a wall;

FIG. 2 is an isometric view of the first embodiment of the hinge of the present invention shown in FIG. 1, but in FIG. 2, the door and wall have been omitted, and FIG. 2 shows the hinge rotated substantially to one end of its range of motion (which, with reference FIG. 1, would be a fully opened position-beyond the partially opened positioned shown in FIG. 1);

FIG. 3 is an isometric view of the hinge shown in FIG. 2, but in FIG. 3, the hinge is shown at the other end of its range of motion compared to FIG. 2;

FIG. 4 is a fragmentary, cross-sectional view taken transversely through the hinge as shown in FIG. 2;

FIG. 5 is a fragmentary, cross-sectional view taken transversely through the hinge as shown in FIG. 3;

FIG. 6 is an exploded, isometric view of the hinge shown in FIG. 3;

FIG. 7 is a view similar to FIG. 1, but FIG. 7 shows a second embodiment of the hinge with a frame on the edges of the door;

FIG. 8 is an exploded, isometric view of the second embodiment of the hinge;

FIG. 9 is a view similar to FIG. 5, but FIG. 9 shows the second embodiment of the hinge illustrated in FIGS. 7 and 8;

FIG. 10 is a view similar to FIG. 4, but FIG. 10 shows the second embodiment of the hinge;

FIG. 11 is a fragmentary, exploded, isometric view, similar to FIG. 6, but FIG. 11 shows a modified form of the first embodiment of the hinge; and

FIG. 12 is a fragmentary, cross-sectional view, similar to FIG. 5, but FIG. 12 shows the components of the modified form of the first embodiment of the hinge after the components shown in FIG. 11 are assembled, and the cross-sectional view is taken transversely through the end plug at one end of the hinge.

### DETAILED DESCRIPTION

While this invention is susceptible of embodiment in many different forms, this specification and the accompanying drawings disclose only some specific forms as examples of the invention. The invention is not intended to be limited to the embodiments so described, however. The scope of the invention is pointed out in the appended claims.

For ease of description, the hinge of this invention is described in one usual (upright) operating position, and terms such as upper, lower, horizontal, etc., are used with reference to this position. It will be understood, however, that the hinge of this invention may be manufactured, stored, transported, used, and sold in an orientation other than the position described.

Figures illustrating the invention show some mechanical elements that are known and that will be recognized by one skilled in the art. The detailed descriptions of such elements are not necessary to an understanding of the invention, and accordingly, are herein presented only to the degree necessary to facilitate an understanding of the novel features of the present invention.

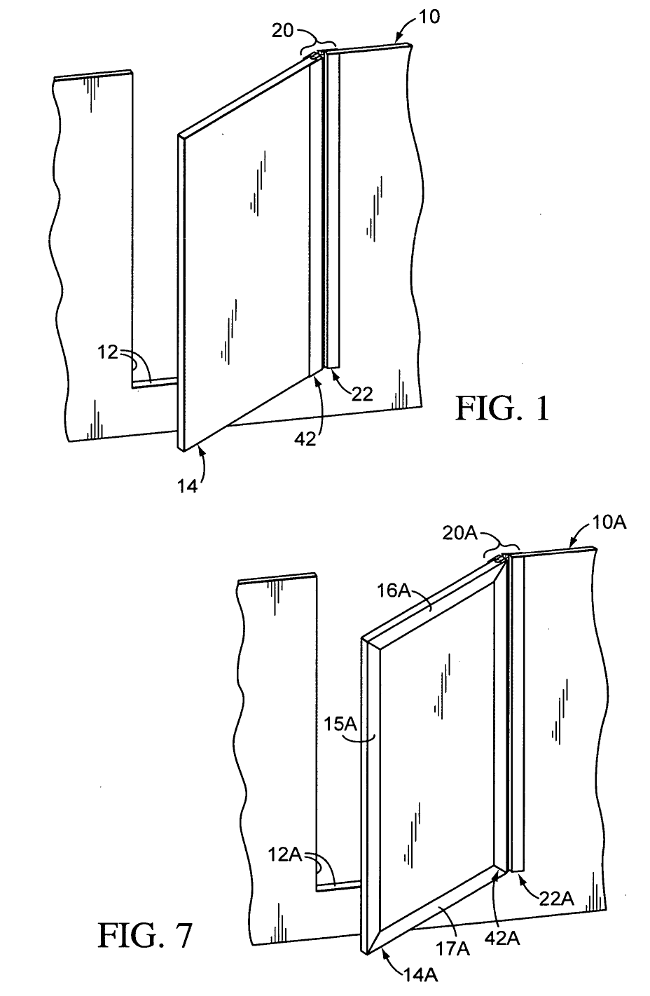

A first embodiment of a hinge of the present invention is illustrated in FIGS. 1-6. FIG. 1 is a simplified perspective view of a wall 10 having a doorway opening 12 which can be closed by a swing door 14 mounted with a first embodiment of the hinge 20 to the wall 10 along one vertical side of the door 14. The wall 10 may be constructed from any suitable material, including glass. The swing door 14 may be constructed from any suitable material, including glass. In the embodiment illustrated in FIG. 1, the door 14 is a glass door which does not have any edge-mounted frame along the horizontal upper edge, horizontal bottom edge, or vertical side edge opposite the hinge 20.

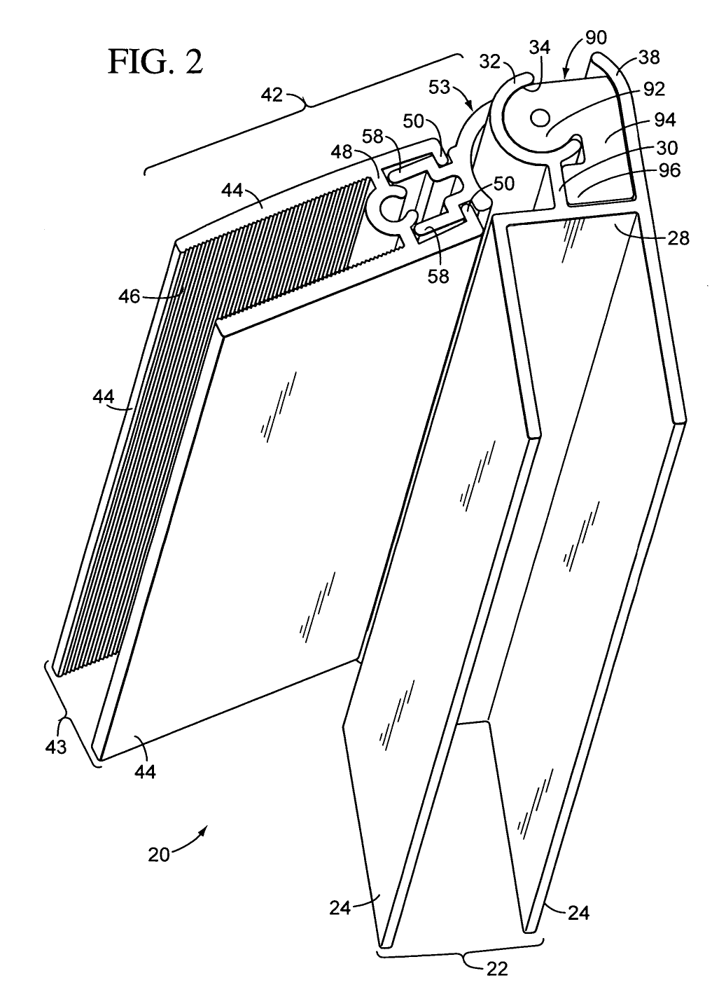

FIGS. 2, 3, and 6 illustrate the first embodiment of the hinge 20 with the wall 10 and door 14 omitted for ease of illustration and for purposes of clearly showing interior details of the hinge components. Further, for ease of illustration in FIGS. 2, 3, and 6, the hinge 20 is shown as having a greatly reduced length or height relative to its width and thickness. It is to be understood that the hinge 20 may have any suitable length, thickness, and width. Further, it is to be understood that the ratio of the hinge length to the thickness of its components or to the width of its components may vary as desired depending upon the particular application for which the hinge 20 is intended.

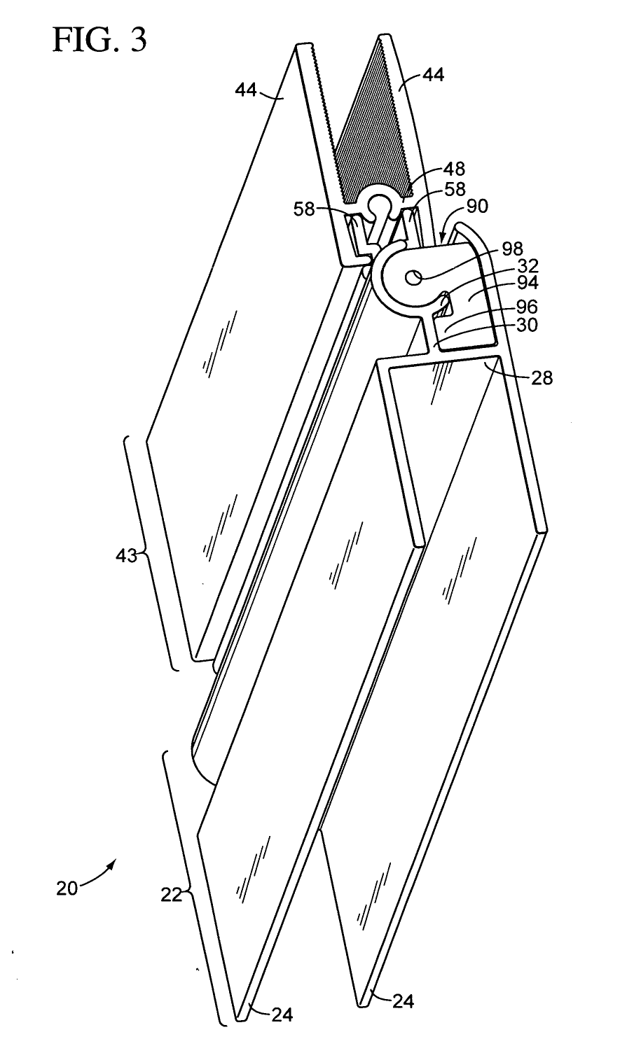

FIG. 2 illustrates the hinge 20 at one end of its range of motion. This may be considered either the full open condition or the full closed condition, depending upon how the hinge is installed. However, in a preferred arrangement as illustrated for the first embodiment of the hinge 20, FIG. 2 shows the hinge 20 in a substantially full open condition wherein the door 14 in FIG. 1 would be pivoted further toward the right to an opening angle of about 110 degrees away from the plane of the wall opening 12. If the door 14 in FIG. 1 was fully closed (i.e., pivoted to a position in which the door 14 is substantially coplanar with the wall opening 12), then the hinge 20 would have the fully closed orientation as illustrated in FIG. 3.

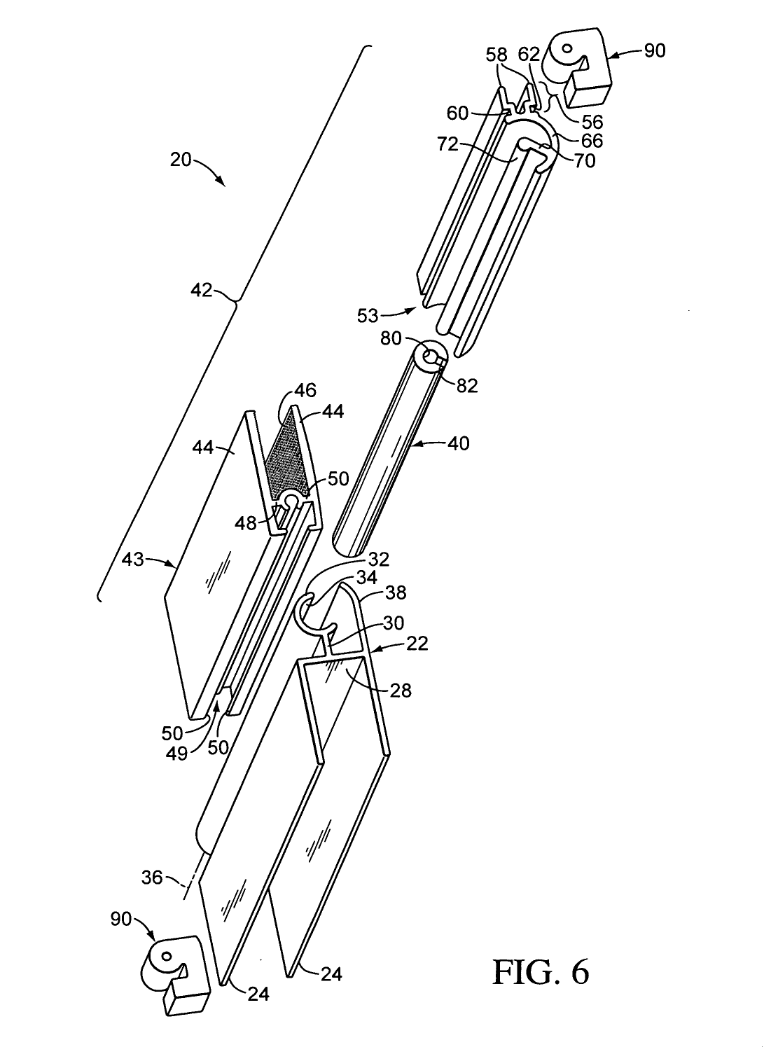

With reference to FIG. 6, the hinge 20 includes a first attachment structure 22 which is adapted to be mounted to the wall 10 (i.e., attached to the wall 10) or other adjacent support structure. In an alternate arrangement in which the hinge 20 is reversed (not illustrated), the first attachment structure 22 could instead be attached to the door 14.

The first attachment structure 22 preferably includes (but need not include) two parallel, spaced-apart walls 24 for receiving the margin of the wall 10 (or door 14). The first attachment structure 22 may be mounted to the wall 10 (or door 14) by any suitable means, such as, for example, with adhesive or with screws or bolts (not illustrated) that extend through apertures (not illustrated) in one or both of the walls 24. Other suitable conventional or special connecting expedients may be employed. The details of the particular connection design form no part of the present invention.

The attachment structure 22 needs to function at least in some way for being mounted to an adjacent element or structure (e.g., wall or door). Indeed, in another alternate design (not illustrated), the first attachment structure 22 may be an integral, unitary part of the adjacent wall 10 (or door 14), or may be a unitary extension of the adjacent wall 10 (or door 14). As used in this specification (including the claims), the description of the “attachment structure” for being “mounted to” an adjacent element or structure (e.g., wall or door) shall be construed to also include (but not be limited to) such an integral, unitary connection or extension between the adjacent element or structure and the “attachment structure.”

In the illustrated preferred embodiment, the first attachment structure 22 can be characterized as a frame portion or jamb to which another part of the hinge 20 is mounted. In a presently preferred form, the first attachment structure 22 is metallic and is preferably extruded from the aluminum alloy designated as “6463 alloy T5” pursuant to the Standardized System of the United States of America Aluminum Association, Inc., where T5 represents a particular heat treatment temper.

In the illustrated preferred embodiment of the first attachment structure 22 (FIG. 6), wherein the structure includes the two walls 24, such walls 24 are connected by a cross wall 28. Projecting from the cross wall 28 is a longitudinally extending leg 30. The distal end of the leg 30 supports a receiving member in the form of a partially cylindrical channel 32 defining a receiving recess 34. The partially cylindrical shape of the channel 32 is oriented around, or defines, a longitudinal pivot axis 36 (FIG. 6) about which the various hinge components can rotate.

The element 32 is described in this specification and in the claims as a “partially cylindrical channel.” In this specification and in the claims, this shall be construed to mean that the channel 32 is defined by an interior concave surface which is partially cylindrical adjacent to the recess 34, but that the exterior surface may have any shape and need not be partially cylindrical per se.

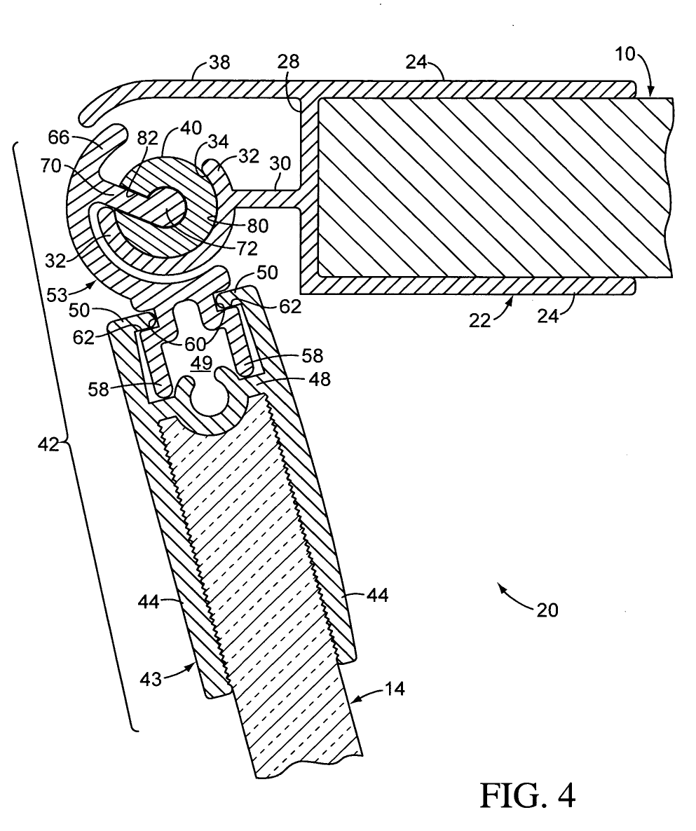

The recess 34 is preferably enclosed by the channel 32 for more than 180 degrees (as viewed in the FIG. 4 transverse cross section which is perpendicular to the pivot axis), and such a configuration defines a longitudinal opening to the recess 34 (in the channel 32) that is less than 180 degrees so that the channel 32 prevents removal or pull out of a bushing 40 (described in detail hereinafter) transversely through the partially cylindrical channel opening.

As can be seen in FIG. 6, the first attachment structure 22 also preferably includes (but need not include) a laterally extending barrier wall or shield wall 38 which is spaced from the partially cylindrical channel 32.

With reference to FIG. 6, the hinge 20 includes a second attachment structure 42 which, in the illustrated, preferred embodiment, is a two-piece, assembly that includes a first component 43 and a second component 53. The first component 43 may be characterized as the door mounting member, or frame portion, or stile 43. The first component 53 of the second attachment structure 42 may be characterized as a hinge member, insert hinge, or insert 53.

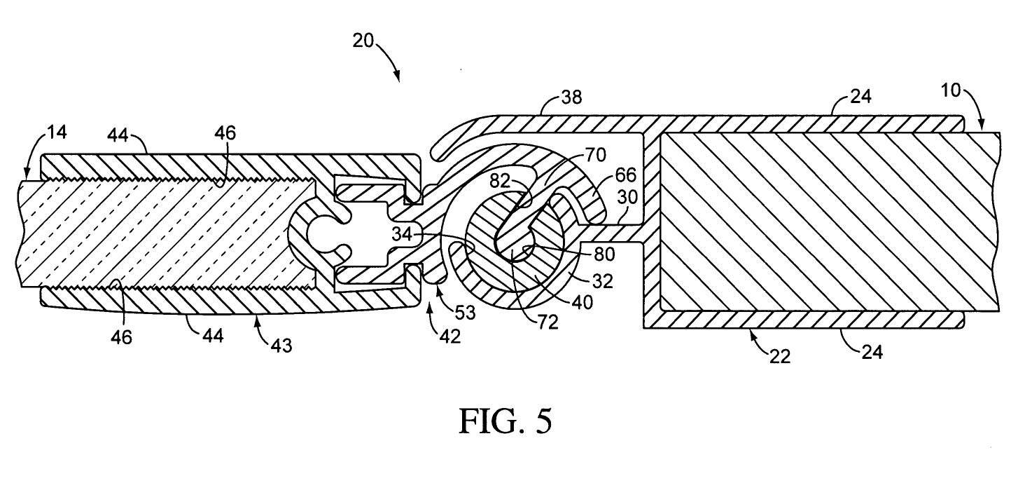

As shown in FIGS. 5 and 6, the stile 43 of the second attachment structure 42 includes two substantially parallel walls 44. The interior surface of each wall 44 is preferably, but need not be, serrated with V-shaped grooves 46. Such V-shaped grooves 46 serve to enhance the gripping capability when stile 43 is secured to the door 14 with adhesive or the like (not visible in FIG. 4). Other means may be provided for attaching the stile 43 to the door 14, including screws (not illustrated) that extend through apertures (not illustrated) in one or both of the walls 44. The hinge 20 could also be mounted to the door 14 with a bolted clamp engagement. These and other suitable expedients may be used where desired, depending upon the materials employed and environmental conditions. Indeed, the door 14 could include the stile 43 as an integral, unitary part, or extension, of the door 14. In a presently preferred form of the stile 43, the stile 43 is extruded from an aluminum alloy, such as the above referenced aluminum 6463 alloy T5.

The preferred embodiment of the stile 43 illustrated in FIG. 6 has a cross wall 48 joining the stile walls 44. Beyond the wall 48, the stile 43 defines a longitudinal cavity 49 with a pair of spaced-apart, confronting lips 50 which together define a reduced width opening to the cavity 49.

The other main component of the second attachment structure 42 is the insert 53 (FIG. 6). In the illustrated preferred embodiment, the insert 53 is mounted in the stile 43 and extends laterally from the stile 43. In a presently preferred embodiment, the insert 53 is metallic and is preferably extruded from aluminum which may be of the same alloy as described above for the stile 43.

The insert 53 is preferably mounted in the stile 43 in a generally fixed, stable manner that prevents wobble or other relative movement between the two components. To this end, the insert 53 includes a retention portion 56 (FIG. 6) that extends into the stile cavity 49. The portion 56 is defined by two spaced-apart legs 58 that each defines a groove 60 for receiving of the stile lips 50 (FIG. 4) which prevent removal of the insert retention portion 56 transversely through the stile lips 50.

The retention portion 56 may be alternatively characterized as having (1) a reduced width neck (as defined by the grooves 60) adjacent the stile lips 50, and (2) an increased width retention shoulder 62 (FIG. 4) within the stile cavity 49 for engaging the stile lips 50 to prevent removal of the insert retention portion 56 transversely through the stile lips 50.

The preferred embodiment of the insert 53 further includes a partially cylindrical member or body 66 (FIG. 6) that is located radially outwardly of the partially cylindrical channel 32. As can be seen in FIG. 4, the partially cylindrical body 66 is at least partially overlapped by the laterally extending shield wall 38 of the first attachment structure 22 throughout the entire range of movement of the hinge 20.

As shown in FIG. 6, the insert 53 has a support arm 70 that projects inwardly from the partially cylindrical body 66. As shown in FIG. 4, the arm 70 projects into the partially cylindrical channel 32 of the first attachment structure 22. As can be seen in FIG. 6, the insert arm 70 has a distal end defined by an enlarged bead or anchor 72.

As can be seen in FIG. 6, the insert arm 70 and its enlarged bead or anchor 72 are adapted to receive the bushing 40 which is mounted thereon by longitudinally sliding the bushing 40 onto, and along, the bead 72 and arm 70. To this end, and as shown in FIG. 6, the bushing 40 has a central longitudinal cavity 80 for receiving the bead or anchor 72 in substantially surface-to-surface contact so as to prevent inward collapse of the bushing 40. The bushing 40 also has the radial slot 82 (FIG. 6) for extending between the cavity 80 and the exterior of the bushing 40. As can be seen in FIG. 4, the bushing slot 82 is adapted to receive the insert arm 70. This arrangement prevents the bushing 40 from being removed transversely from the insert arm 70. The bushing 40 can be removed from (and installed on) the insert 53 by longitudinally sliding the busing 40 relative to the insert 53, or, alternatively, by sliding the insert 53 relative to the bushing 40.

The assembly of the insert 53 with the bushing 40 mounted thereon can be readily installed in the stile 43 by longitudinally sliding the retention portion 56 of the insert 53 into the cavity 49 of the stile 43 (or, alternatively, by sliding the stile 43 onto the retention portion 56 of the insert 53).

The first attachment structure or jamb 22 can be then assembled with the insert 53, bushing 40, and stile 43 by longitudinally sliding the first attachment structure 22 along the bushing 40 (or, alternatively, by sliding the bushing 40, insert 53, and stile 43 together relative to the first attachment structure 22) so that the bushing 40 is disposed within the partially cylindrical channel 32 of the first attachment structure 22.

In the presently preferred form of the invention, the bushing 40 has a surface hardness that is less than the surface hardness of the partially cylindrical channel 32. This facilitates rotation of the bushing 40 (together with the insert 53 and stile 43) relative to the channel 32 as the hinge 20 moves from one end of its range of motion to the other end of its range of motion (e.g., between a closed position as shown in FIG. 5 and its fully open position as shown in FIG. 4). In a most preferred form of the invention, the bushing 40 is a synthetic thermoplastic polymer, such as nylon or polyvinylchloride, while the channel 32 (and the rest of the first attachment structure 22) and the insert 53 are made from an aluminum alloy as described above. The novel bushing 40 thus prevents metal-on-metal contact during the rotation of the hinge components. This facilitates a smooth motion, minimizes rubbing, and minimizes or eliminates the formation of black marks or other wear marks on the adjacent rotatable components.

With reference to FIGS. 4 and 5, it can be seen that the shield wall 38 of the first attachment structure 22 and the partially cylindrical member or body 66 of the insert 53 function separately and together to provide an enclosing function or barrier function with respect to the more inwardly disposed portions of the hinge structure (e.g., the bushing 40). When the hinge 20 is installed as shown in FIGS. 1 and 5 wherein the first attachment structure shield wall 38 is on the inside of a shower room or shower stall, the shield wall 38 provides a significant barrier to penetration from spraying water. Similarly, the partially cylindrical member or body 66 of the insert 53 further shields the bushing 40 and guide channel 32. Further, both the shield wall 38 and the partially cylindrical body 66 provide an aesthetically pleasing enclosure or covering around the interior part of the hinge 20. Even when the hinge 20 is fully opened as shown in FIG. 4, the shield wall 38 and partially cylindrical member or body 66 provide an aesthetically pleasing covering system that also functions as a barrier system to minimize the ingress of spraying water.

In the preferred form of the invention, the bushing 40 is tightly mounted on the insert arm 70 and on the insert arm bead or anchor 72 so that the interior cavity 80 of the bushing 40 is in substantially surface-to-surface contact. There are substantially no voids between the inside of the bushing 40 and the arm 70 and its bead 72. Thus, there are no interior void spaces into which the bushing 40 could be deflected. This means that the bushing 40 is less likely to be deformed from its design configuration, and is therefore more likely to properly function as a part of the rotatable hinge system which may be subjected to significant loading conditions imposed by various forces and torques.

Because the first attachment structure channel 32 extends more than 180 degrees around the bushing 40, the bushing 40 cannot readily pull out transversely, even when subjected to high lateral pull-out loads. On the other hand, even if the bushing 40 were to fail, as by fracturing or perhaps partially melting in a fire, the hinge system components will not completely disengage. By providing an appropriate minimum spacing between the inside of the first attachment structure shield wall 38 and the insert partially cylindrical body 66, and by providing an appropriate overlapping arrangement between the insert partially cylindrical body 66 and the guide channel 32, the insert 53 is prevented from separating laterally (transversely as viewed in FIGS. 4 and 5) from the guide channel 32 even if the bushing 40 is completely destroyed and substantially non-existent. Lateral pull-out is prevented by the lateral or transverse interference between the insert 53 and the first attachment structure 22 that would occur if an attempt is made to pull the components apart laterally (i.e., transversely as viewed in FIGS. 4 and 5). Thus, the arrangement would maintain the insert 53 engaged, at least loosely, to the first attachment structure 22. This would prevent the door 14 from falling—although door 14 may be cocked at a slight angle with respect to the normal, true vertical orientation.

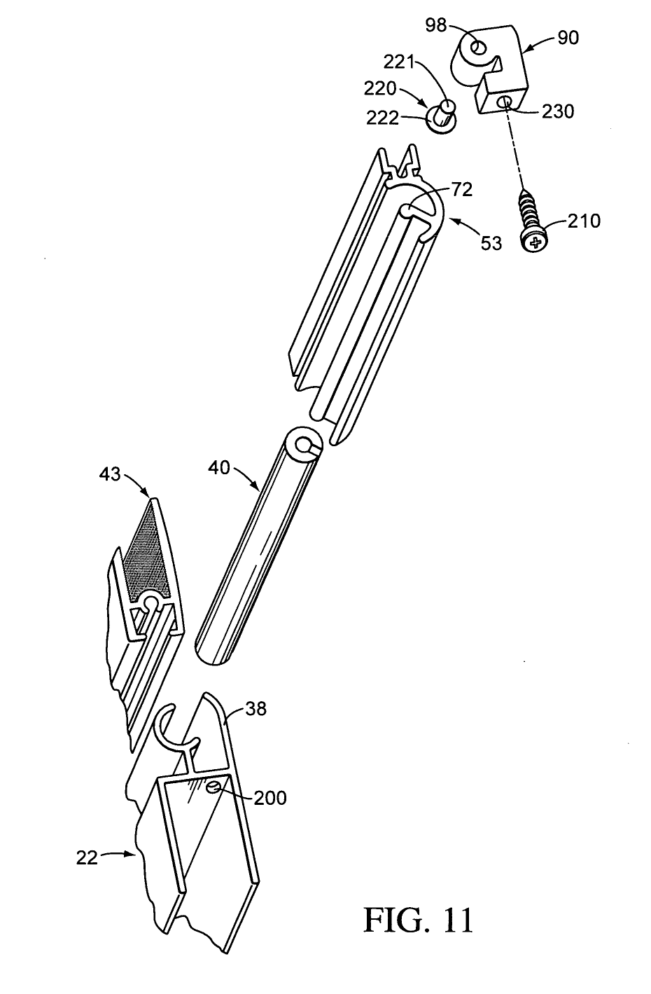

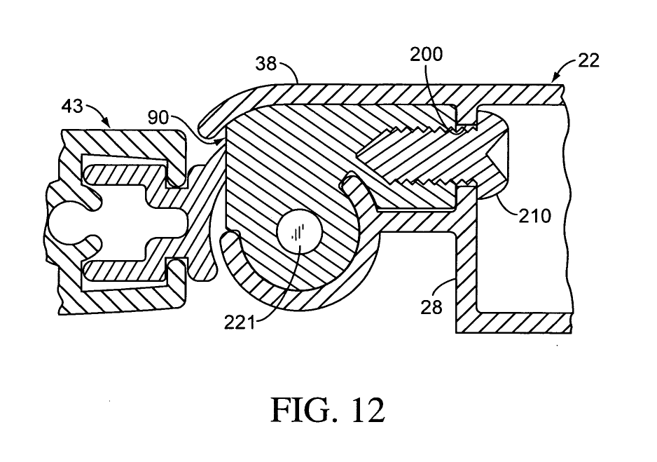

With reference to FIG. 6, the assembled components may be retained or locked longitudinally by means of end caps or end plugs 90. As can be seen in FIGS. 2 and 3, each end plug 90 is shaped with a partially cylindrical head 92 for being received within the channel 32. Each plug 90 also includes a laterally extending leg 94 with a foot 96 for being received between the first attachment structure shield wall 38 and leg 30 outwardly of the partially cylindrical channel 32. Each plug 90 may be made from a suitable material. In the preferred embodiment, each plug 90 is made from a synthetic thermoplastic polymer, preferably polyvinylchloride or nylon. Each plug 90 may be secured in place by suitable means. According to one proposed arrangement, each plug 90 can be designed to be conveniently secured in the first attachment structure 22 by expanding the plug 90 into a tight fit engagement. To this end, each plug 90 can be provided with an aperture 98 for receiving a suitable tapered shank screw (not illustrated) that, when screwed into the aperture 98, expands or deforms the surrounding material of the plug 90 outwardly into tight engagement with the adjacent portions of the first attachment structure 22. Stainless steel rivets (not illustrated) could instead be used to secure the plugs 90. Also, instead of the plugs 90, other suitable retention devices could be used. A presently most preferred form of securing end plugs 90 in the structure is described hereinafter with respect to FIGS. 11 and 12 wherein a screw 210 is employed to secure each plug 90 to the shield wall 38.

With reference to FIG. 5, it can be seen that at one end of hinge range of motion (e.g., such as the fully closed position), the distal edge of the partially cylindrical member or body 66 of the insert 53 engages the leg 30 of the first attachment structure 22. This prevents further movement of the hinge 20 in the closing direction (e.g., this prevents further movement of the stile 43 relative to the first attachment structure 22 in the clockwise direction as viewed in FIG. 5).

With reference to FIG. 4, the limit of the open condition of the hinge 20 is established by the engagement of the distal edge of the partially cylindrical channel 32 with the leg 70 of the insert 53.

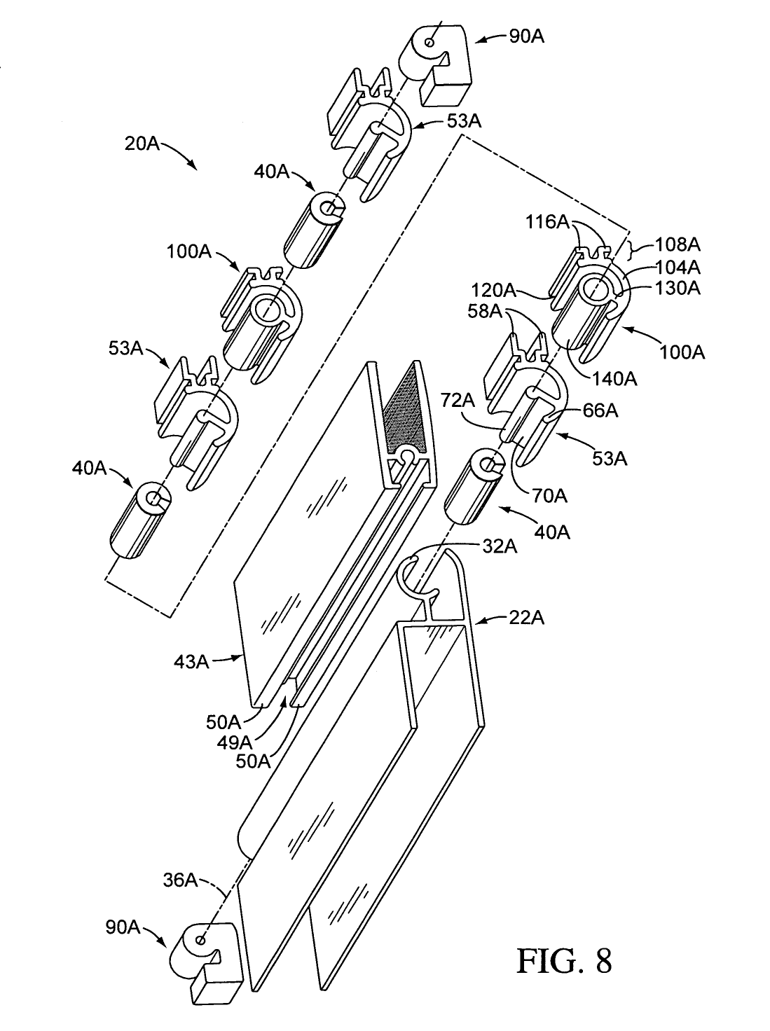

FIG. 7 illustrates a second embodiment of the hinge of the present invention. In FIG. 7, the second embodiment of the hinge is designated generally by the reference number 20A. The second embodiment of the hinge 20A is shown mounting a door 14A to a wall 10A at an opening 12A. The door 14A may be constructed from any suitable material, including glass. In the second embodiment illustrated in FIG. 7, the door 14A is disposed within an edge-mounted frame of aluminum channel members comprising a vertical outer edge frame member 15A, a top edge frame member 16A, and a bottom edge frame member 17A. For ease of illustration, and to better illustrate interior details, the wall 10A and door 14A have been omitted from the exploded, isometric view of the components of the hinge 20A illustrated in FIG. 8.

It is to be understood that the hinge 20A may have any length, thickness, and width, and that the ratio of the hinge length to the thickness of its components or to the width of its components may vary as desired depending upon the particular application for which the hinge 20A is intended.

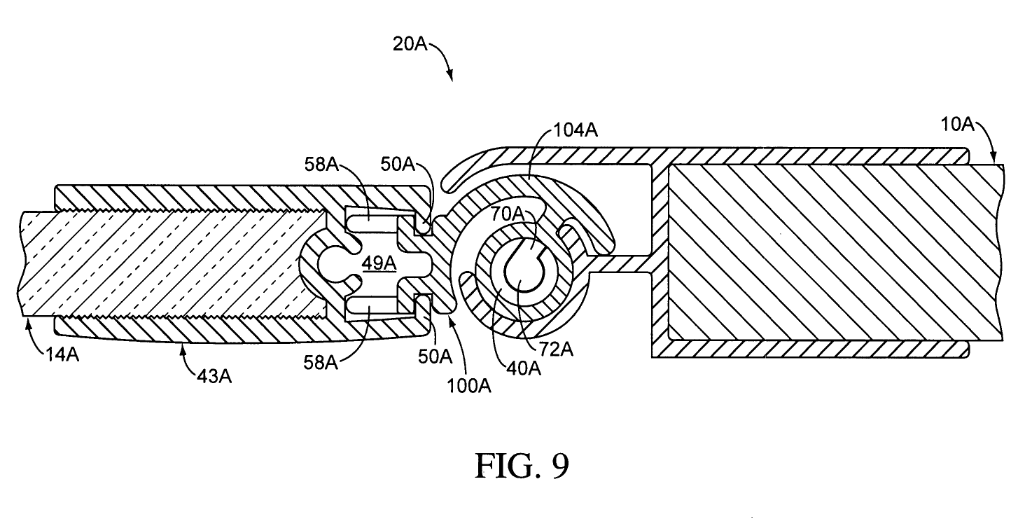

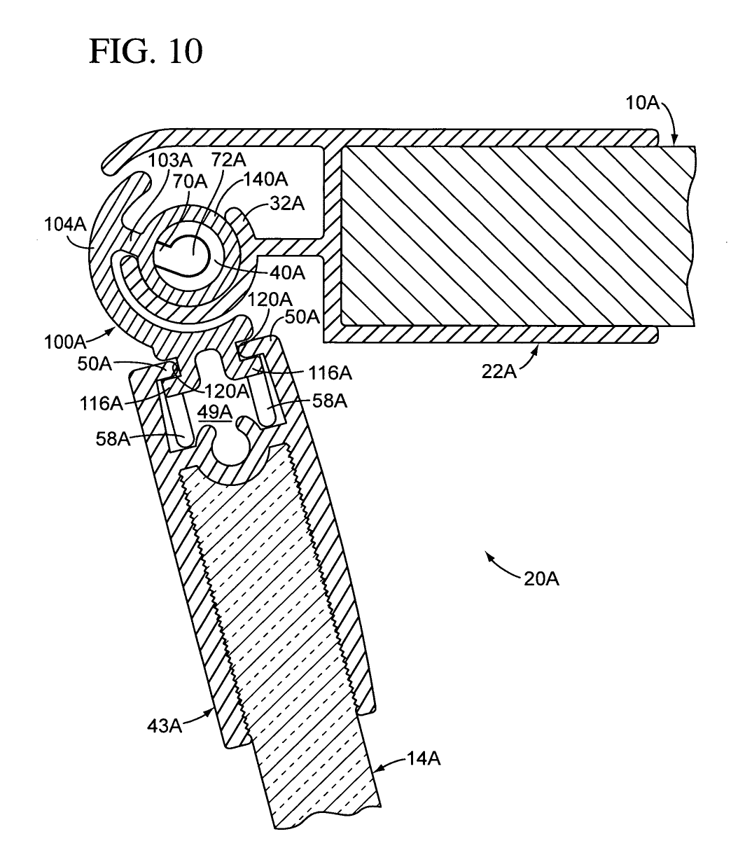

FIG. 10 illustrates the hinge 20A at one end of its range of motion. This may be considered either the full open condition or the full closed condition, depending upon how the hinge 20A is installed. However, in a preferred arrangement illustrated for the second embodiment of the hinge 20A in FIGS. 7-10, the hinge 20A is shown in FIG. 10 in a substantially full open condition wherein, the door 14 in FIG. 7 would be pivoted further toward the right to an opening angle of about 110 degrees away from the plane of the wall opening 12A. If the door 14A in FIG. 7 was fully closed (i.e., pivoted to a position in which it is substantially co-planar with the wall opening 12A), then the hinge 20A would have the fully closed orientation as illustrated in FIG. 9.

As illustrated in FIG. 8, the components of the second embodiment of the hinge 20A include a first attachment structure 22A, a second attachment structure in the form of a multi-piece assembly of a stile 43A, three insert hinges or inserts 53A, three bushings 40A, two spacers 100A, and two end caps or end plugs 90A. The first attachment structure 22A, the stile 43A, and the plugs 90A are identical with the first embodiment attachment structure 22, the stile 43, and the plugs 90, respectively, described above with reference to FIGS. 1-6.

The configurations of the second embodiment bushings 40A and inserts 53A are essentially identical with the first embodiment bushing 40 and insert 53, respectively, as described above with reference to FIGS. 1-6, except that the lengths or heights of the second embodiment bushings 40A and inserts 53A are shorter relative to the second embodiment attachment structure 22A and stile 43A so as to accommodate a plurality of bushings 40A and inserts 53A assembled within the attachment structure 22A and stile 43A.

The spacers 100A employed in the second embodiment of the hinge 20A are additional components which are not employed in the first embodiment of the hinge 20 described above with reference to FIGS. 1-6.

In a preferred form of the second embodiment of the hinge 20A illustrated in FIGS. 7-10, each bushing 40A and insert 53A has the same length (i.e., height), and that length is shorter than the length of the first attachment structure 22A and style 43A as measured along the length of the pivot axis (axis 36A in FIG. 8). In the second embodiment of the hinge 20A, the bushings 40A and inserts 53A are arranged in cooperatively associated subassemblies wherein each subassembly consists of one of the bushings 40A mounted on one of the inserts 53A, and wherein such subassemblies are then longitudinally spaced apart along the pivot axis. A spacer 40A is disposed between two of the spaced-apart subassemblies. In the preferred arrangement, one of the subassemblies of a bushing 40A and insert 53A is disposed at the bottom of the hinge 20A, a second subassembly of a bushing 40A and insert 53A is disposed at the middle of the length (height) of the hinge 20A, and a third subassembly of a bushing 40A and insert 53A is disposed at the top of the hinge 20A. A lower spacer 100A is disposed between the bottom and middle subassemblies, and an upper spacer 100A is disposed between the middle subassembly and top subassembly.

When the components are assembled, and viewed from the same orientation as FIGS. 2 and 3 depicting the first embodiment of the hinge 20, the second embodiment of the hinge 20A has virtually an identical exterior appearance. Consequently, when the second embodiment of the hinge 20A is in its fully opened position, the second embodiment of the hinge 20A looks the same as the first embodiment hinge 20 illustrated in FIG. 2. Similarly, when the second embodiment hinge 20A is in the fully closed position, the exterior of the second embodiment hinge 20A looks the same as the first embodiment hinge 20 illustrated in FIG. 3.

FIGS. 9 and 10 show the second embodiment of the hinge 20A in a transverse cross section taken through one of the spacers 100A. Analogous transverse cross sectional views taken through the bushing 40A an insert 53A would be substantially identical with the cross-sectional views of the first embodiment of the hinge 20A as shown in FIGS. 4 and 5.

As can be seen in FIG. 8, each insert 53A has a pair of legs 58A, a partially cylindrical member or body 66A, a longitudinally extending arm 70A that projects radially inwardly and that has a distal end bead or anchor 72A. This configuration is identical with the configuration of the first embodiment insert 53 described above with reference to FIG. 6. In the cross-sectional views of the second embodiment of the hinge 20A illustrated in FIGS. 9 and 10, the legs 58A of the insert 53A are visible in the background along with the insert arm 70A and bead or anchor 72A. The portions 58A, 70A, and 72A of the insert 53A are not shown in cross section in FIGS. 9 and 10 because those portions are beyond the cross sectional view plane of FIGS. 9 and 10, and the remaining portions of the insert 53A are hidden behind the cross section portions of the spacer 100A. Also in the background in FIGS. 9 and 10 is a portion of the end of one of the bushings 40A which is mounted on the insert arm 70A and bead or anchor 72A.

The illustrated, preferred embodiment of the spacer 100A is designed for mounting or installation in the stile 43A in substantially the same manner that the insert 53A is mounted in the stile 43A (and also in the same manner that the first embodiment insert 53 is mounted in the stile 43). To this end, as can be seen in FIG. 8, the stile 43A has a cavity 49A and a pair of spaced-apart, confronting lips 50A which together define a reduced width opening to the cavity 49A. The spacer 100A includes a partially cylindrical wall 104A, and a retention portion 108A extends laterally from the wall 104A through the stile lips 50A (FIG. 10) into the stile cavity 49A.

The spacer retention portion 108A (FIG. 8) includes a reduced width neck which is adapted to lie within, and adjacent to, the stile lips 50A as shown in FIG. 10. The spacer retention portion 108A includes an increased width retention shoulder 112A (FIG. 8) beyond the reduced width neck so as to engage the stile lips 50A as shown in FIG. 10 to prevent removal of the spacer 100A transversely through the stile lips 50A.

The spacer retention portion 108A may be alternatively characterized as being defined by two spaced-apart legs 116A (FIG. 8) that each (1) extends laterally from the spacer partially cylindrical wall 104A (FIG. 10), and (2) defines a groove 120A (FIG. 10) for receiving one of the stile lips 50A. This arrangement allows each spacer 100A to be assembled with the stile 43A by inserting the spacer retention portion 108A in the stile cavity 49A and longitudinally sliding the spacer 100A into position in the stile 43A along with the inserts 53A and bushings 40A mounted on the inserts 53A.

Each spacer 100A further includes a longitudinally extending arm 130A (FIGS. 8 and 10) which projects radially inwardly from the partially cylindrical wall 104A. At the distal end of the longitudinal arm 130A is a generally cylindrical hollow pintle 140A (FIGS. 8 and 10). As can be seen in FIG. 10, when the components are fully assembled, the pintle 140A is disposed in the partially cylindrical channel 32A of the first attachment structure 22 to accommodate rotation of the spacer 100A at least part way around the pivot axis. The pintle 140A has a partially cylindrical surface defamed around the pivot axis for engaging the partially cylindrical channel 32A of the first attachment structure 22A.

In a presently preferred form of the spacer 100A, the spacer 100A is molded from a synthetic thermoplastic polymer such as polyvinylchloride. Each bushing 40A, however, is preferably molded from nylon. Other comparable thermoplastic materials, or other materials, could also be used.

When all of the components of the hinge 20A shown in FIG. 8 are assembled, the components are retained against longitudinal displacement by the end plugs 90A in the same manner as described above with respect to employment of the end plugs 90 for the first embodiment illustrated in FIGS. 1-6.

In the second embodiment of the hinge 20A, the nylon bushing 40A has a surface hardness that is less than the surface hardness of the partially cylindrical channel 32A of the first attachment structure 22A which is preferably made from metal (e.g., the aluminum alloy as described above with reference to the first embodiment of the first attachment structure 22 illustrated in FIGS. 1-6).

The second embodiment of the hinge 20A may be modified to employ fewer or more components. For example, the hinge could be provided with a bottom subassembly (of a bushing 40A and insert 53A) separated from a top subassembly (of a bushing 40A and an insert 53A) by only one, long spacer 10A. On the other hand, the hinge 20A could be provided with more than three subassemblies of a bushing 40A and insert 53A along with an appropriate number of spacers 100A to occupy the spaces between the increased number of subassemblies.

The second embodiment of the hinge 20A illustrated in FIGS. 7-10 provides substantially all of the benefits and advantages described above with respect to the first embodiment of the hinge 20 illustrated in FIGS. 1-6. The second embodiment of the hinge 20A is particularly suitable for use with mounting a framed door.

The second embodiment of the hinge 20A is also especially suitable for use in mounting a door, such as a glass door, to a wall of a shower stall or shower room. It will be appreciated that the partially cylindrical wall 104A of the spacer 100A can function as a water barrier or shield for those sections of the hinge 20A that are occupied by the spacers 100A. In addition, the partially cylindrical wall 104A of each spacer 100A provides an aesthetically pleasing appearance, especially when the door is opened (FIG. 10).

In a typical shower stall installation in the United States of America, the second embodiment of the hinge 20A is used with a framed shower door that has a height of 68 inches. With such a door, the attachment structure or joint 22A is 68 inches high or long, the stile 43A is 68 inches high, each insert 53A is 1 inch high or long, and each bushing 40A mounted thereon an insert 53 is also 1 inch high or long. There are three such subassemblies of inserts and bushings mounted at spaced-apart locations along the height of the hinge 20A wherein one of the subassemblies is at the bottom of the hinge, another of the subassemblies is in the middle of the hinge, and the third subassembly is at the top of the hinge. Between the bottom subassembly and middle subassembly is one of the spacers 100A, and between the middle subassembly and the top subassembly there is a second spacer 100A. Each of the two spacers 100A has a length or height of about 32-½ inches or a little less to accommodate the insertion of the plugs 90 at the top and bottom ends of the first attachment structure 22A.

If the first embodiment of the hinge 20 illustrated in FIGS. 1-6 is employed on a 68 inch high door, then the first attachment structure or jamb 22 has a length or height of 68 inches, the stile 43 has a length or height of 68 inches, and the insert 53 and bushing 40 each has a length or height of 68 inches or a little less to accommodate the insertion of the plugs 90 at the top and bottom ends of the first attachment structure 22.

In the first embodiment of the hinge 20, the presently preferred material for the bushing 40 is polyvinylchloride. However, in the second embodiment of the hinge 20A, the preferred material for the bushing 40A is nylon, but the preferred material for the spacer 100A is polyvinylchloride.

FIGS. 11 and 12 illustrate an alternate, but presently most preferred, form of securing the end plugs 90 in the first embodiment of the hinge shown in FIGS. 1-6. The same alternate method of securing the end plugs can also be used with the second embodiment of the hinge shown in FIGS. 7-10.

With reference to FIG. 11, the first attachment structure 22 is provided with an aperture 200 in the cross wall 28 (one aperture 200 at the top end of the hinge and one aperture 200 at the bottom end of the hinge). Each aperture 200 is adapted to receive a sheet metal screw 210.

Also, a metal rivet 220, having a shank 221 and a head 222, is installed in the central aperture 98 of each end plug 90 on the inwardly facing side of the end plug so that the rivet head 222 bears against the bead 72 of the insert 53. This provides a smaller, harder bearing surface for the insert 53 as it rotates (together with the bushing 40 and second attachment structure stile 43) throughout the range of motion of the hinge.

After all of the components except the screws 210 are assembled, each screw 210 can be inserted into one of the apertures 200 and screwed into the adjacent end plug 90 to secure the end plug 90 in the hinge as shown in FIG. 12. Depending on the hardness of the material from which the end plug 90 is made, a pilot hole 230 (FIG. 11) may or may not be provided in the end plug 90 for the screw 210.

It will be readily apparent from the foregoing detailed description of the invention and from the illustrations thereof that numerous variations and modifications may be effected without departing from the true spirit and scope of the novel concepts or principles of this invention.

What is claimed is:

1. A hinge for connecting a swing door to an adjacent support structure in a hinged relationship, said hinge comprising:
a first attachment structure for being mounted to either said door or said adjacent support structure and having a partially cylindrical channel defining a longitudinal pivot axis;
a second attachment structure for being mounted to the other of said door and said adjacent support structure and having a longitudinally extending mounting arm projecting into said partially cylindrical channel of said first attachment structure; and
a bushing that (1) is mounted on said arm of said second attachment structure, (2) is disposed in said partially cylindrical channel of said first attachment structure, and (3) has a partially cylindrical exterior surface which (a) is defined around said pivot axis for engaging said partially cylindrical channel of said first attachment structure, and (b) has a surface hardness that is less than the surface hardness of said partially cylindrical channel, whereby said second attachment structure can rotate at least part way around said pivot axis.

2. The hinge in accordance with claim 1 in which said partially cylindrical channel of said first attachment structure defines a receiving recess that is enclosed for more than 180 degrees in transverse cross section perpendicular to said pivot axis so as to define a longitudinal opening in said partially cylindrical channel that is less than 180 degrees which prevents removal of said bushing transversely through said partially cylindrical channel longitudinal opening.

3. The hinge in accordance with claim 1 in which said arm of said second attachment structure has a distal end defined by an enlarged anchor;
said bushing is a separate component that has (1) a central longitudinal cavity for receiving said anchor in substantially surface-to-surface contact to prevent inward collapse of said bushing, and (2) a radial slot extending between said void and the exterior of said bushing for receiving said arm whereby said bushing is prevented from being removed transversely from said arm of said second attachment structure.

4. The hinge in accordance with claim 1 in which said first attachment structure includes
(1) a laterally extending leg supporting said partially cylindrical channel of said first attachment structure; and
(2) a laterally extending shield wall spaced from said partially cylindrical channel to accommodate rotation of at least a portion of said second attachment structure between said shield wall and said bushing when said hinge is moved from one end of its range of motion to the other end of its range of motion.

5. The hinge in accordance with claim 1 in which
said second attachment structure is an assembly of
(1) a stile, and
(2) an insert that
(a) is mounted in said stile,
(b) extends laterally from said stile, and
(c) defines said arm on which said bushing is mounted.

6. The hinge in accordance with claim 5 in which
said first attachment portion, said stile, and said insert are each made of aluminum; and
said bushing is made of nylon or polyvinylchloride.

7. The hinge in accordance with claim 5 in which said insert includes a partially cylindrical body that
(1) is disposed radially outwardly of said partially cylindrical channel of said first attachment structure;
(2) supports said arm that projects into said partially cylindrical channel of said first attachment structure; and
(3) is at least partially overlapped by said laterally extending shield wall of said first attachment structure throughout the entire range of movement of said hinge.

8. The hinge in accordance with claim 5 in which said first attachment structure includes
(1) a laterally extending leg supporting said partially cylindrical channel of said first attachment structure; and
(2) a laterally extending shield wall spaced from said partially cylindrical channel to accommodate rotation of at least a portion of said second attachment structure between said shield wall and said bushing when said hinge is moved from one end of its range of motion to the other end of its range of motion.

9. The hinge in accordance with claim 5 in which
said bushing and said insert have the same length, and that length is shorter than said stile as measured along the length of said pivot axis;
said hinge includes a plurality of said bushings and a plurality of said inserts arranged in cooperatively associated subassemblies wherein each subassembly consists of one of said bushings mounted on one of said inserts, and wherein said subassemblies are longitudinally spaced apart along said pivot axis; and
said hinge further includes at least one longitudinal spacer disposed between two of said spaced-apart subassemblies.

10. The hinge in accordance with claim 9 in which said spacer is made of polyvinylchloride.

11. The hinge in accordance with claim 9 in which said spacer
(1) is mounted to said stile,
(2) includes a partially cylindrical wall that is disposed radially outwardly of said partially cylindrical channel of said first attachment structure, and
(3) includes a pintle that
(a) is disposed in said partially cylindrical channel of said attachment structure, and
(b) has a partially cylindrical exterior surface defined around said pivot axis for engaging said partially cylindrical channel of said first attachment structure to accommodate rotation of said spacer at least part way around said pivot axis.

12. The hinge in accordance with claim 11 in which said pintle is hollow and is connected to said partially cylindrical wall with a longitudinal support wall.

13. The hinge in accordance with claim 11 in which
said stile defines (1) a cavity, and (2) a pair of spaced-apart, confronting lips which together define a reduced width opening to said cavity;
said spacer includes a retention portion extending laterally from said partially cylindrical wall through said stile lips into said stile cavity; and
said spacer retention portion includes (1) a reduced width neck adjacent said stile lips, and (2) an increased width retention shoulder within said stile cavity for engaging said stile lips to prevent removal of said spacer retention portion transversely through said stile lips.

14. The hinge in accordance with claim 13 in which in which said spacer retention portion is defined by two spaced-apart legs that each (1) extends laterally from said partially cylindrical wall of said spacer, and (2) defines a groove for receiving one of said stile lips.

15. The hinge in accordance with claim 11 in which
said first attachment structure is a jamb that includes
(1) a laterally extending leg supporting said partially cylindrical channel of said first attachment structure; and
(2) a laterally extending shield wall spaced from said partially cylindrical channel to accommodate rotation of at least a portion of said second attachment structure between said shield wall and said bushing when said hinge is moved from one end of its range of motion to the other end of its range of motion;
said spacer includes a partially cylindrical wall that
(1) is disposed radially outwardly of said partially cylindrical channel; and
(2) is at least partially overlapped by said laterally extending shield wall of said jamb throughout the entire range of movement of said hinge.

16. The hinge in accordance with claim 5 in which
said insert includes a partially cylindrical body that is disposed radially outwardly of said partially cylindrical channel of said first attachment structure; and
said arm projects radially inwardly from said partially cylindrical body into said partially cylindrical channel of said first attachment structure.

17. The hinge in accordance with claim 16 in which
said stile defines (1) a cavity, and (2) a pair of spaced-apart, confronting lips which together define a reduced width opening to said cavity;
said insert includes a retention portion extending laterally from said body through said stile lips into said stile cavity; and
said insert retention portion includes (1) a reduced width neck adjacent said stile lips, and (2) an increased width retention shoulder within said stile cavity for engaging said stile lips to prevent removal of said insert retention portion transversely through said stile lips.

18. The hinge in accordance with claim 17 in which said insert retention portion is defined by two spaced-apart legs that each (1) extends laterally from said partially cylindrical body of said insert, and (2) defines a groove for receiving one of said stile lips.

19. A hinge for connecting a swing door to an adjacent support structure in a hinged relationship, said hinge comprising:
a first attachment structure for being mounted to either said door or said adjacent support structure and having a partially cylindrical channel defining a longitudinal pivot axis;
a second attachment structure for being mounted to the other of said door and said adjacent support structure and having a longitudinally extending mounting arm projecting into said partially cylindrical channel of said first attachment structure; and
a bushing that (1) is mounted on said arm of said second attachment structure, (2) is disposed in said partially cylindrical channel of said first attachment structure, and (3) has a partially cylindrical exterior surface which (a) is defined around said pivot axis for engaging said partially cylindrical channel of said first attachment structure, and (b) has a surface hardness that is less than the surface hardness of said partially cylindrical channel whereby said second attachment structure can rotate at least part way around said pivot axis, said partially cylindrical channel of said first attachment structure defining a longitudinal receiving recess that extends parallel to said pivot axis and that is enclosed for more than 180 degrees in transverse cross section perpendicular to said pivot axis so as to define a longitudinal opening in said partially cylindrical channel that is less than 180 degrees which prevents removal of said bushing transversely through said partially cylindrical channel longitudinal opening, said first attachment structure including (1) a laterally extending leg supporting said partially cylindrical channel of said first attachment structure, and (2) a laterally extending shield wall spaced from said partially cylindrical channel to accommodate rotation of at least a portion of said second attachment structure between said shield wall and said bushing when said hinge is moved from one end of its range of motion to the other end of its range of motion, said second attachment structure including a partially cylindrical body that (1) is disposed radially outwardly of said partially cylindrical channel of said first attachment structure, (2) supports said arm that projects into said partially cylindrical channel of said first attachment structure, and (3) is at least partially overlapped by said laterally extending shield wall of said first attachment structure throughout the entire range of movement of said hinge.
